(19) United States
(12) Patent Application Publication
(10) Pub. No.: US 2026/0238091 A1
(43) Pub. Date: Aug. 13, 2026

(54) METHOD FOR ATTACHING A TEMPERATURE SENSOR TO A WELD CONNECTION OF A HAIRPIN STYLE ELECTRIC MOTOR STATOR

(71) Applicant: Schaeffler Technologies AG & Co. KG, Herzogenaurach (DE)

(72) Inventor: Jacob Sheradin, North Canton, OH (US)

(73) Assignee: Schaeffler Technologies AG & Co. KG, Herzogenaurach (DE)

(21) Appl. No.: 19/049,623

(22) Filed: Feb. 10, 2025

(51) Int. Cl. H02K 11/25; B23K 26/21; G01K 1/14; G01K 1/16; H02K 15/32

(52) U.S. Cl. CPC H02K 11/25; B23K 26/21; G01K 1/14; G01K 1/16; H02K 15/32

(57) ABSTRACT

An electric motor that includes a rotor and a stator, with the rotor being mounted for rotation relative to the stator. The stator includes a plate stack, and a plurality of stator coil wires assembled with the plate stack, with at least some ends of respective ones of the stator coil wires that extend beyond the plate stack being joined together via welded connections in order to complete at least one stator coil circuit. A metal clip is connected to at least one of the welded connections and extends along at least one of the coil wires. The metal clip defines a cavity between itself and the at least one of the coil wires. A temperature sensor is located in the cavity and allows monitoring of the stator coil temperature. A method of assembly is also provided.

### TECHNICAL FIELD

The disclosure relates to electric motors, and particularly to the stator of an electric motor. More particularly, the disclosure relates to temperature sensors for the stator which are used to ensure efficient motor operation and safety.

### BACKGROUND

The stator of an electric motor may be composed of steel plates/laminations having stator coils that wind through grooves in the steel plates. A common construction of motors involves the laser welding of “hairpins”, U-shaped segments of the coil wires which are bent into various shapes, inserted through the laminated plates, further bent into shape, and then welded together at ends thereof that extend out from axial ends of the plate stack to form welded connections that complete the electrical circuit for the stator coils. FIG. 1 shows a portion of a stator coil where the welded connections are visible, and FIG. 2 shows an enlarged schematic view of one such welded connection. In use, the temperature of the coil wires is monitored using a temperature sensor, which can be a negative-temperature-coefficient thermistor (NTC). Due to space constraints and loss considerations, temperature sensors are most commonly affixed to either end of the hairpin using an adhesive or plastic clip (as shown in FIG. 1), outside of the area where hairpin part of the coil passes through the stator laminations that form the plate stack.

High power density is critical for market competitiveness in the supply of electric motors and often results in motors which operate near their thermal limits. Accuracy in temperature measurement is therefore important, and can be negatively affected by the known temperature sensor mounting.

It would be desirable to provide an arrangement that improves the accuracy of temperature sensing for an electric motor without affecting performance or other characteristics of the stator.

### SUMMARY

In one aspect, an electric motor is provided that includes a rotor and a stator, with the rotor being mounted for rotation relative to the stator. The stator includes a plurality of laminated steel plates assembled in a plate stack, a plurality of stator coil wires assembled with the plate stack, with at least some ends of respective ones of the stator coil wires that extend beyond the plate stack being joined together via welded connections in order to complete at least one stator coil circuit. A metal clip is connected to at least one of the welded connections and extends along at least one of the coil wires of the same hairpin. The metal clip defines a cavity between itself and the at least one of the coil wires. A temperature sensor is located in the cavity and allows monitoring of the stator coil temperature. This arrangement provides higher accuracy in sensing the stator temperature and allows electric motor operation closer to the performance envelope by reducing inaccuracy and uncertainty in the temperature measurement. Further, the metal clip can be connected to the stator coil wires as part of the existing assembly process during formation of the welded connections. The life of the metal clip is also better than the prior known plastic or adhesive temperature sensor connections.

In one aspect, the metal clip is comprised of at least one of copper or brass. Other materials may also be used that are compatible with welding to the stator coil wires.

In one aspect, the metal clip includes, starting at a proximal end at the welded connection, an elongate body that extends parallel to one of the stator coil wires, a generally convex portion that extends away from the stator coil wire, and a distal end that is spaced apart from the stator coil wire, the generally convex portion defining the cavity. Preferably, at least one of the elongate body or the generally convex portion is resilient and applies a spring force that biases the temperature sensor against the stator coil wire.

In one aspect, a portion of the cavity formed by the metal clip is generally part-circular, generally rectilinear, or generally triangular in cross-section. Here, the term ‘generally’ is intended to encompass shapes that are similar, and preferably that have a path that is within 0.1 inches at any given point from the noted geometric shape.

In another aspect, the metal clip includes a hole defined therein for fixation of the temperature senor. Fixation can be by a mechanical fastening to the hole or a adhesive/resin that extends around part of the temperature sensor and into the hole.

In another aspect, the metal clip includes a proximal end that is connected to the stator coil wire at the welded connection, and includes serrations at or near the distal end, opposite to the proximal end. The location and size of the serrations can vary.

In another aspect, the metal clip comprises a relatively high thermal conductivity metal to improve thermal bonding between the temperature sensor and the stator coil wire. Preferably, the thermal conductivity is at least 100 W/m·K.

In another aspect, the welded connections are a laser welded connection.

In one specific embodiment, there are at least two of the metal clips, and one of the metal clips is connected to a respective one of the welded connections on each axial side of the plate stack, and there are at least two of the temperature sensors, with one of the temperature sensors being located in a respective one of the metal clips on each axial side of the plate stack.

In another aspect, a method of assembling a stator for an electric motor is provided, the method including:
laminating a plurality of steel plates together into a plate stack;
installing stator coil wires through the plate stack;
welding at least some ends of respective ones of the stator coil wires that extend beyond the plate stack together to form welded connections in order to complete at least one stator coil circuit;
welding a metal clip to at least one of the welded connections with the metal clip extending along one of the coil wires, said metal clip defining a cavity between said metal clip and said one of the coil wires; and
installing a temperature sensor in the cavity.

In one aspect, the method can further include that the welding of the metal clip to at least one of the welded connections takes place simultaneously with the welding of the ends of the stator coil wires together to form the welded connection.

In one aspect, the method can further include that the metal clip is comprised of at least one of copper or brass.

In one aspect, the method can further include that the metal clip includes, starting at a proximal end at the welded connection, an elongate body that extends parallel to one of the stator coil wires, a generally convex portion that extends away from the stator coil wire, and a distal end that is spaced apart from the stator coil wire, the generally convex portion defining the cavity, and the method further includes at least one of the elongate body or the generally convex portion resiliently applying a spring force that biases the temperature sensor against the stator coil wire.

In one aspect, the method can further include fixing the temperature sensor to the metal clip using a hole defined in the metal clip.

In one aspect, the method can further include improving a thermal bonding of the temperature sensor to the stator coil wire by using a relatively high thermal conductivity metal for the metal clip.

In one aspect, the method can further include that the welding comprises laser welding.

In one aspect, the method can further include the welding of the metal clip to at least one of the welded connections on the stator coil wires that extend beyond the plate stack is on one side axial of the plate stack, and the method further includes welding another one of the metal clips to one of the welded connections on an opposite side of the plate stack, and the installing includes installing one of the temperature sensors into each of the metal clips such that a respective one of the temperature sensors is located on each axial side of the plate stack

One or more of the above features can be combined to provide a stator as well as an electric motor having such a stator with improved reliability and temperature monitoring.

### BRIEF DESCRIPTION OF THE DRAWING(S)

The foregoing Summary as well as the following Detailed Description will be best understood when read in conjunction with the appended drawings, which illustrate an embodiment according to the disclosure. In the drawings:

FIG. 1 is a perspective view showing a portion of an electric motor stator coil in accordance with a prior art electric motor in which stator coil wires that extend out from the axial ends of the plate stack that form the stator are connected via welded connections to form “hairpins”.

FIG. 2 is an enlarged schematic view of a single hairpin formed by two coil wires that are connected via the welded connection as shown in FIG. 1.

FIG. 3 is a schematic cross-sectional view through an electric motor in accordance with the present disclosure that includes a metal clip connected to at least one of the welded connections that extends along one of the coil wires in order to secure a temperature sensor against the coil wire in an area where it extends out of the plate stack.

FIG. 4 is an enlarged detail view showing the configuration of the first embodiment of the metal clip from FIG. 3 along one of the coil wires and being connected via the welded connection used to form the hairpin that connects to the ends of the stator coil wires together, with a temperature sensor being located in a cavity (shown with a part-circular shape in cross-section) formed by the metal clip and being pressed against one of the coil wires.

FIG. 5 is a side view of a second embodiment of a metal clip that can be connected via the welded connection used to form the hairpin in which the cavity has a generally rectilinear shape in cross-section.

FIG. 6 is a top view of the metal clip shown in FIG. 5 that also includes an optional fixation hole for the temperature sensor.

FIG. 7 is a side view of a further embodiment of a metal clip that can be connected to the stator coil wire at the welded connection that forms the hairpin in which the cavity to hold the temperature sensor has a generally triangular shape in cross-section and also includes serrations for enhanced gripping.

FIG. 8 is an end view of the metal clip shown in FIG. 7.

FIG. 9 is a flow chart showing a method of assembly a stator for an electric motor in accordance with an embodiment of the present disclosure.

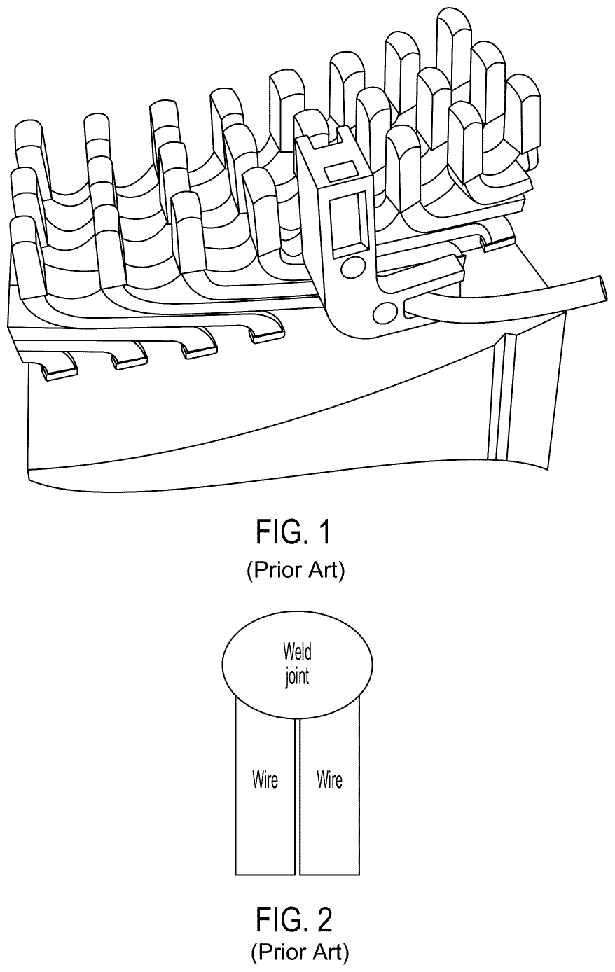

### DETAILED DESCRIPTION

Certain terminology is used in the following description for convenience only and is not limiting. “Axial” refers to a direction along an axis. A reference to a list of items that are cited as “at least one of a, b, or c” (where a, b, and c represent the items being listed) means any single one of the items a, b, or c, or combinations thereof. The terms “generally”, “about” and “approximately” are to be construed as within 10% of a stated value or ratio, or are as otherwise noted herein with respect to a geometric shape. The terminology includes the words specifically noted above, derivatives thereof, and words of similar import.

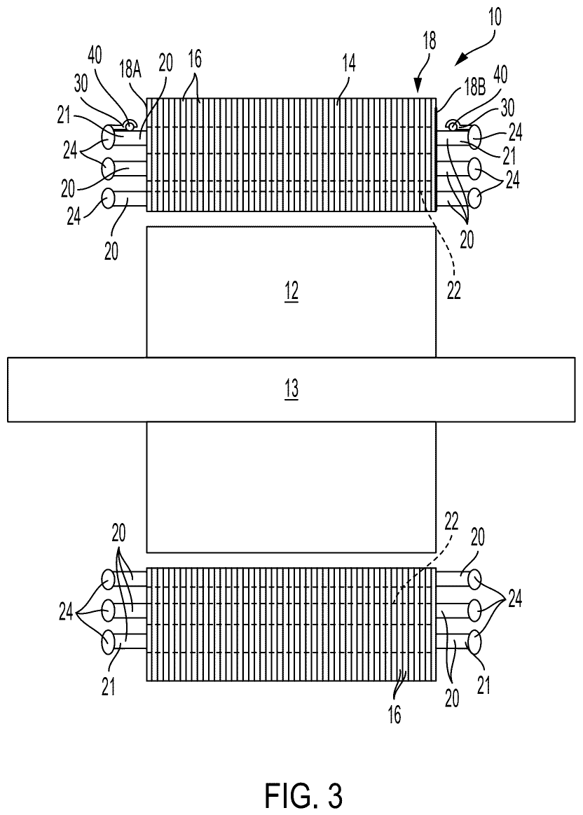

Referring now to FIG. 3, an electric motor 10 in accordance with an embodiment of the present disclosure is shown in cross-section. The electric motor 10 includes a rotor 12, as well as a stator 14, with the rotor 12 shown rotatably mounted relative to the stator 14. In the illustrated embodiment, the rotor 12 is mounted on a shaft 13 for rotation within the stator 14. However, other configurations are possible for example in radial flux motors with a rotor outside the stator or an axial flux motor where the rotor and stator are side-by-side. The stator 14 includes a plurality of laminated steel plates 16 that are assembled into a plate stack 18. A plurality of stator coil wires 20 are assembled with the plate stack 18 and preferably extend through channels or grooves 22 defined in the plate stack 18. At least some ends 21 of respective ones of the stator coil wires 20 that extend beyond the plate stack 18 are joined together via welded connections 24 in order to complete at least one stator coil circuit. As will be recognized by those skilled in the art, there are a plurality of stator coil circuits and therefore a plurality of the welded connections 24 are generally necessary in practice.

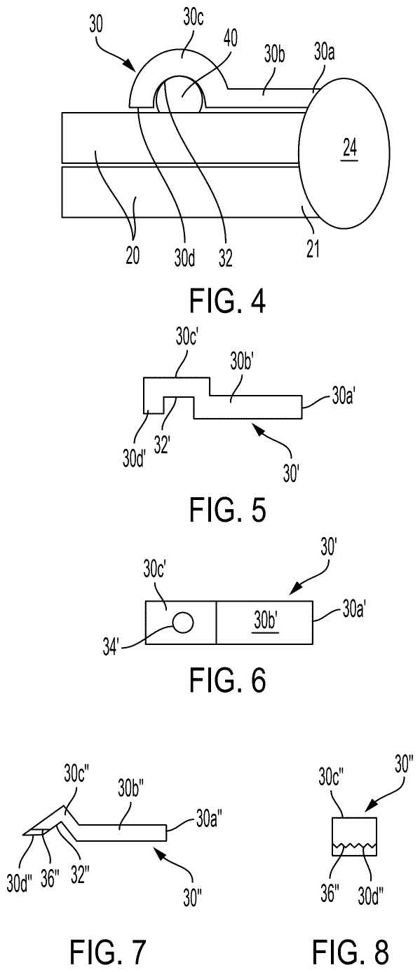

In accordance with the present disclosure and in order to achieve higher reliability, as shown in FIGS. 3 and 4 a metal clip 30 is connected to at least one of the welded connections 24 and extends along one or more of the coil wires 20 of the same hairpin, with the metal clip 30 defining a cavity 32 between the metal clip 30 and the one or more of the coil wires 20 which is adapted to receive a temperature sensor 40. As shown in the embodiment of FIG. 3, a temperature sensor 40 is located in the cavity on at least a first axial end 18A of the plate stack 1. In the illustrated embodiment, metal clips 30 are located on each axial end 18A, 18B of the plate stack 18 and one of the temperature sensors 40 is located in the cavity 32 defined by each of the metal clips 30. This arrangement with the metal clips 30 can be used on any motor which has a hairpin style weld connection between the stator coil wires 20.

Still with reference to FIGS. 3 and 4, in the first embodiment of the metal clip 30, the cavity is generally part-circular in cross-section. As noted below, other shapes are possible.

In one aspect, the metal clip 30 may be made of a same metal as the coil wires 20, which are typically copper. The metal clip 30 can be made of at least one of copper or brass. However, other metals which are compatible with the welded connection 24 may also be used.

As shown in detail in FIG. 4, the metal clip 30 includes, starting at a proximal end 30a at the welded connection 24, an elongate body 30b that extends parallel to one of the stator coil wires 20, a generally convex portion 30c that extends away from the stator coil wire 20, and a distal end 30d that is spaced apart from the stator coil wire 20 by an amount that is less than a height of the temperature sensor 40, with the generally convex portion 30c defined in the cavity 32.

In one embodiment, at least one of the elongate body 30b or the convex portion 30c is resilient and applies a spring force that biases the temperature sensor 40 against the stator coil wire 20.

In one aspect, the metal clip 20 may comprise a relatively high thermal conductivity metal, for example at least 100 W/m·K, to improve thermal bonding with and between the temperature sensor 40 and the stator coil wire 20. This provides more accurate temperature sensing then the previously known plastic clips or adhesive connections.

In a preferred arrangement, the welded connections 20 are laser welded connections.

Referring now to FIGS. 5 and 6, a second embodiment of a metal clip 30′ in accordance with the present disclosure is shown. The second embodiment of the metal clip 30′ is similar to the first embodiment 30. The differences are noted below.

In the second embodiment of the metal clip 30′, the cavity 32′ formed by the generally convex portion 30c′ has a rectilinear or generally rectilinear form. The proximal end 30a′, elongate body 30b′, and distal end 30d′ generally correspond to the first embodiment. Further, as shown in FIG. 6, the metal clip 30′ may include an optional hole 34′ defined therein for fixation of the temperature sensor 40. It is also noted that the metal clip 30 in accordance with the first embodiment as shown in FIGS. 3 and 4 could also include the fixation hole. However, this is optional in any case.

With respect to the construction of the second embodiment of the metal clip 30′, this is preferably formed of the same materials and attached in the same manner as noted above in connection with the first embodiment of the metal clip 30.

Referring now to FIGS. 7 and 8, a third embodiment of the metal clip 30″ is shown. The third embodiment of the metal clip 30″ is similar to the first embodiment of the metal clip 30 as described above. However, here the cavity 32″ formed by the generally convex portion 30c″ has a generally triangular form in cross-section. Those skilled in the art will recognize that the shape of the generally convex portion 30c, 30c′, 30c″ can be varied to fit a particular shape of the temperature sensor 40 and the disclosed shapes for the cavity 32, 32′, 32″ described herein are not considered exclusive or limiting.

Further, as shown in FIGS. 7 and 8, the metal clip 30″ includes serrations 36″ at or near the distal end 30d″, opposite to the proximal end 30a″.

To the extent that a spring force is applied by the metal clip 30, 30′, 30″, the length of the elongate body 30b, 30b′, 30b″ can be varied in order to achieve a desired spring force. The cross-section can also be varied. Further, the distal end 30d, 30d′, 30d″ of the metal clip 30. 30′, 30″ is adapted not to contact the stator coil wire 20 in order to ensure that the metal clip 30 can apply the spring force bias to press the temperature sensor 40 against the stator coil wire 20.

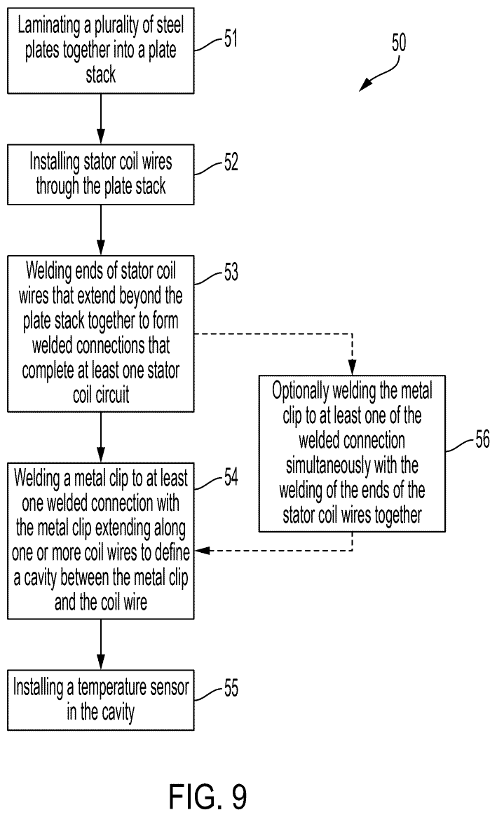

Referring now to FIG. 9, a method of assembling the stator 14 for an electric motor 10 is schematically shown. Here, the method 50 includes a first step 51 of laminating a plurality of the steel plate 16 together in order to form the plate stack 18. In a second step 52, the stator coil wires 20 are installed through the plate stack 18. In a third step 53, at least some ends of the respective ones of the stator coil wires 20 that extend beyond the plate stack 18 are welded together to form welded connections 24 in order to complete at least one stator coil circuit and preferably a plurality of stator coil circuits. In a fourth step 54, the metal clip 30, 30′, 30″ is welded to at least one of the welded connections 20 with the metal clip 30, 30′, 30″ extending along one of the coil wires 20, with the metal clip defining a cavity 32, 32′, 32″ between the metal clip 30, 30′, 30″ and the one of the coil wires 20. In a fifth step 55, the temperature sensor 40 is installed in the cavity 32, 32′, 32″.

In an optional step 56, the welding of the metal clip 30, 30′, 30″, at its distal end 30a, 30a′, 30a″ to the welded connection 24, takes place simultaneously with the welding of the ends 21 of the stator coil wires 20 together to form the welded connections 24.

The metal clips 30, 30′, 30″ may be as described above. To the extent that a fixation hole 34′ is provided, this can be used to secure the temperature sensor 40 to the metal clip 30, 30′, 30″.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein. It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

### LOG OF REFERENCE NUMERALS

10 electric motor
12 rotor
13 shaft
14 stator
16 steel plates
18 plate stack
18A first axial end
18B second axial end
20 stator coil wires
22 channels or grooves
24 welded connections
30, 30′, 30″ metal clip
30a, 30a′, 30a″ proximal end
30b, 30b′, 30b″ elongate body
30c, 30c′, 30c″ generally convex portion
30d, 30d′, 30d″ distal end
32 cavity
34′ hole
36″ serrations
40 temperature sensor
50 Method of manufacture
51-56 Method steps

1. An electric motor, comprising:
a rotor; and
a stator, the rotor being mounted for rotation relative to the stator, the stator including a plurality of laminated steel plates assembled in a plate stack, a plurality of stator coil wires assembled with the plate stack, at least some ends of respective ones of the stator coil wires that extend beyond the plate stack being joined together via welded connections in order to complete at least one stator coil circuit; and
a metal clip connected to at least one of the welded connections and extending along at least one of the coil wires, said metal clip defining a cavity between said metal clip and said at least one of the coil wires; and
a temperature sensor located in the cavity.

2. The electric motor of claim 1, wherein the metal clip is comprised of at least one of copper or brass.

3. The electric motor of claim 1, wherein the metal clip includes, starting at a proximal end at the welded connection, an elongate body that extends parallel to one of the stator coil wires, a generally convex portion that extends away from the stator coil wire, and a distal end that is spaced apart from the stator coil wire, the generally convex portion defining the cavity.

4. The electric motor of claim 3, wherein at least one of the elongate body or the generally convex portion is resilient and applies a spring force that biases the temperature sensor against the stator coil wire.

5. The electric motor of claim 1, wherein a portion of the cavity formed by the metal clip is generally part-circular, generally rectilinear, or generally triangular in cross-section.

6. The electric motor of claim 1, wherein the metal clip includes a hole defined therein for fixation of the temperature senor.

7. The electric motor of claim 1, wherein the metal clip includes a proximal end that is connected to the stator coil wire at the welded connection, and includes serrations at or near a distal end, opposite to the proximal end.

8. The electric motor of claim 1, wherein the metal clip comprises a relatively high thermal conductivity metal to improve thermal bonding between the temperature sensor and the stator coil wire.

9. The electric motor of claim 1, wherein the welded connections are a laser welded connections.

10. The electric motor of claim 1, wherein there are at least two of the metal clips, and one of the metal clips is connected to a respective one of the welded connections on each axial side of the plate stack, and there are at least two of the temperature sensors, with one of the temperature sensors being located in a respective one of the metal clips on each axial side of the plate stack.

11. A method of assembling a stator for an electric motor, the method comprising:
laminating a plurality of steel plates together into a plate stack;
installing stator coil wires through the plate stack;
welding at least some ends of respective ones of the stator coil wires that extend beyond the plate stack together to form welded connections in order to complete at least one stator coil circuit;
welding a metal clip to at least one of the welded connections with the metal clip extending along at least one of the coil wires, said metal clip defining a cavity between said metal clip and said at least one of the coil wires; and
installing a temperature sensor in the cavity.

12. The method of claim 11, wherein the welding of the metal clip to at least one of the welded connections takes place simultaneously with the welding of the ends of the stator coil wires together to form the welded connection.

13. The method of claim 11, wherein the metal clip is comprised of at least one of copper or brass.

14. The method of claim 11, wherein the metal clip includes, starting at a proximal end at the welded connection, an elongate body that extends parallel to one of the stator coil wires, a generally convex portion that extends away from the stator coil wire, and a distal end that is spaced apart from the stator coil wire, the generally convex portion defining the cavity, and the method further includes at least one of the elongate body or the generally convex portion resiliently applying a spring force that biases the temperature sensor against the stator coil wire.

15. The method of claim 11, further comprising fixing the temperature sensor to the metal clip using a hole defined in the metal clip.

16. The method of claim 11, further comprising improving a thermal bonding of the temperature sensor to the stator coil wire by using a relatively high thermal conductivity metal for the metal clip.

17. The method of claim 11, wherein the welding comprises laser welding.

18. The method of claim 11, further comprising the welding of the metal clip to at least one of the welded connections on the stator coil wires that extend beyond the plate stack is on one side axial of the plate stack, and the method further comprises welding another one of the metal clips to one of the welded connections on an opposite side of the plate stack, and the installing includes installing one of the temperature sensors into each of the metal clips such that a respective one of the temperature sensors is located on each axial side of the plate stack.
